(19) United States
(12) Patent Application Publication
(10) Pub. No.: US 2024/0410197 A1
(43) Pub. Date: Dec. 12, 2024

(54) LOCKING DEVICE, UNLOCKING KEY, AND DOOR

(71) Applicant: LIXIL Corporation, Tokyo (JP)

(72) Inventors: Fuminori AKIYAMA, Tokyo (JP); Takashi MITSUHASHI, Tokyo (JP)

(73) Assignee: LIXIL Corporation, Tokyo (JP)

(21) Appl. No.: 18/697,912

(22) PCT Filed: Oct. 6, 2022
(86) PCT No.: PCT/JP2022/037394

§ 371 Date: Apr. 2, 2024

(30) Foreign Application Priority Data
Oct. 7, 2021 (JP) 2021-165707

(51) Int. Cl. E05B 35/00

(52) U.S. Cl. CPC E05B 35/001

(57) ABSTRACT

Provided is a locking device that allows a plurality of cylinder locks having different security levels to be locked and unlocked with the same unlocking key. A locking device comprising: a cylinder lock having an outer cylinder, and an inner cylinder that is rotatably fit with the outer cylinder; and an unlocking key corresponding to a key hole formed in the inner cylinder, wherein a projecting part is formed at the back end of the key hole, and a positioning recess part that can be fit with the projecting part is formed at the front end of the unlocking key.

### CROSS-REFERENCE TO RELATED APPLICATIONS

This application is a national stage application under 35 U.S.C. 371 of International Application No. PCT/JP2022/037394, filed Oct. 6, 2022, which claims the priority of Japanese Application No. 2021-165707, filed Oct. 7, 2021. The entire contents of each priority application is incorporated herein by reference.

### FIELD OF THE DISCLOSURE

The present disclosure relates to a locking device, an unlocking key, and a door.

### BACKGROUND OF THE DISCLOSURE

Locking devices including cylinder locks and unlocking keys, installed in doors of residences and the like, are known in the prior art. A cylinder lock includes an outer cylinder, an inner cylinder that rotatably engages with the outer cylinder, and tumbler pins that restrict the rotation of the inner cylinder. Indentations and protrusions for positioning the tumbler pins at predetermined positions are formed on the unlocking key. By inserting the unlocking key into the keyhole of the cylinder lock, the tumbler pins coincide with the positions between the outer and inner cylinders, enabling the inner cylinder to rotate. In order to position the indentations and protrusions of the unlocking key at the tumbler pins, the unlocking key includes shoulders that contact the surface of the keyhole. In the disclosed locking device (e.g., refer to Japanese Unexamined Patent Application, Publication No. 2007-191861), when the unlocking key is inserted into the keyhole up to the point where the shoulders come in contact with the surface of the keyhole, the indentations and protrusions of the unlocking key coincide in position with the tumbler pins.

### SUMMARY OF THE DISCLOSURE

Meanwhile, there is a demand for enabling a single unlocking key to operate different security levels of plural cylinder locks. The security levels of cylinder locks can be altered by changing the number of tumbler pins. For example, in the same house, it may be required to set a higher security level for the cylinder lock of the entrance door, and a lower security level for the cylinder locks of the doors of each room, while an identical unlocking key should be able to operate all these cylinder locks.

A high-security cylinder lock and a corresponding unlocking key get longer as the number of tumbler pins increases. Therefore, as an approach, the tumbler pin configuration of a low-security cylinder lock and a high-security cylinder lock may be partially standardized, allowing a long unlocking key corresponding to the high-security cylinder lock to operate the short cylinder lock as well. However, in the case of conventional unlocking keys, when the shoulders contacting the surface of the keyhole is used for positioning, if a long unlocking key is inserted into a short cylinder lock, the shoulders will not contact the surface of the keyhole, and are thus unable to perform positioning. Therefore, in such cases, the low-security short cylinder lock has to be unnecessarily lengthened to match the long unlocking key, leading to problems such as increased space requirements for installing the cylinder lock and higher manufacturing costs.

As an alternative approach, the positioning may be performed by causing the tip of the key to contact the end of the keyhole. However, with this approach, when the key is inserted, a force in the rotational direction is applied to the handle around the tip of the key, lifting the tumbler pins, and is thus unable to achieve high precision.

The present disclosure has been completed in view of the above circumstances, and aims to provide a locking device that enables an identical unlocking key to lock and unlock different security levels of plural cylinder locks.

The present disclosure relates to a locking device that includes: a cylinder lock including an outer cylinder and an inner cylinder that rotatably engages with the outer cylinder; and an unlocking key corresponding to a keyhole formed in the inner cylinder. A protrusion is formed at an end of the keyhole, and a positioning indentation is formed at the tip of the unlocking key, in which the indentation can engage with the protrusion.

### BRIEF DESCRIPTION OF THE FIGURES

FIG. 1 is a perspective view illustrating a configuration of a locking device according to a first embodiment;

FIG. 2 is an exploded perspective view illustrating a configuration of a cylinder lock according to the first embodiment;

FIG. 3 is a front view of the cylinder lock according to the first embodiment;

FIG. 4 is a rear view of the cylinder lock according to the first embodiment;

FIG. 5 is a top view of an unlocking key according to the first embodiment;

FIG. 6 is a view of the unlocking key according to the first embodiment, as viewed from the direction of insertion into the keyhole;

FIG. 7 is an enlarged view of an essential part of FIG. 5, illustrating a structure of a tip of the unlocking key according to the first embodiment;

FIG. 8 is a view illustrating an engaged state of an indentation at the tip of the unlocking key and a protrusion at the end of the keyhole in FIG. 7;

FIG. 9 is a perspective view illustrating a configuration of a locking device according to a second embodiment;

FIG. 10 is a side view illustrating the configuration of the locking device according to the second embodiment;

FIG. 11 is a rear view of a cylinder lock according to the second embodiment;

FIG. 12 is a view of an unlocking key according to the second embodiment, as viewed from the direction of insertion into the keyhole;

FIG. 13 is a perspective view illustrating an engaged state of the indentation and protrusion of the unlocking key according to the second embodiment;

FIG. 14 is a top view (enlarged view of the essential part) of the unlocking key according to the second embodiment; and

FIG. 15 is a front view of a door equipped with the cylinder lock of the present embodiment.

### DETAILED DESCRIPTION OF THE DISCLOSURE

### First Embodiment

### Locking Device

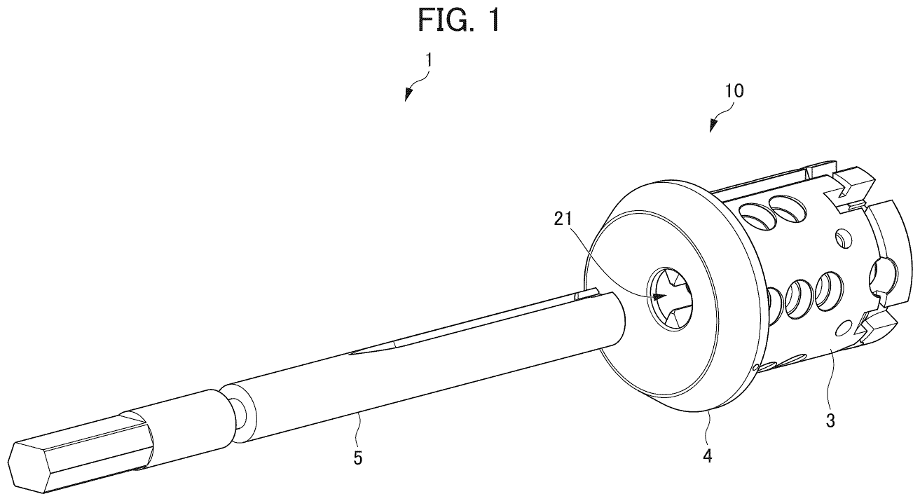

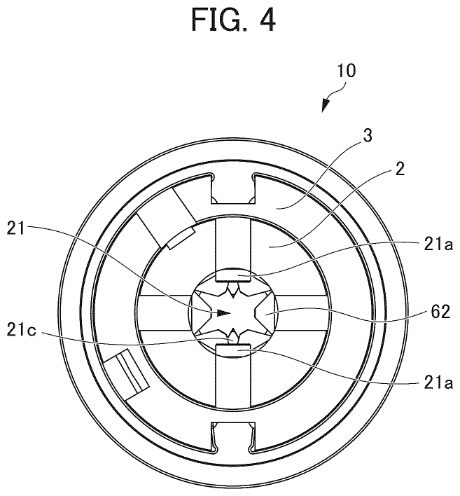

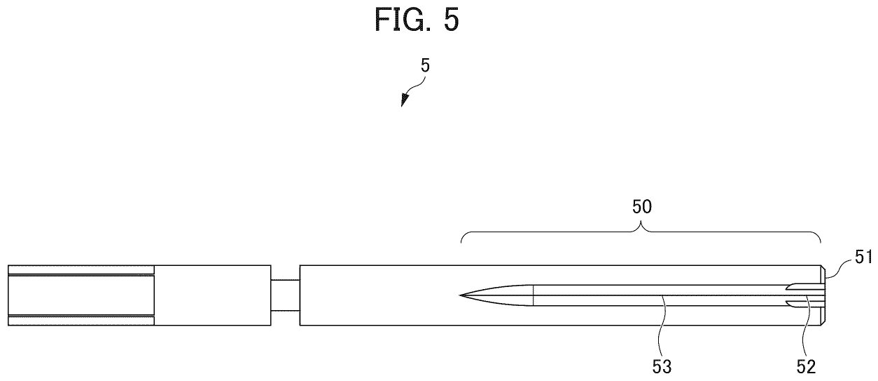

As illustrated in FIG. 1, a locking device 1 according to the present embodiment includes a cylinder lock 10 and an unlocking key 5 that can lock and unlock the cylinder lock 10 by being inserted into a keyhole 21 of the cylinder lock 10. An indentation 52 for positioning is formed at the tip of the unlocking key 5 as illustrated in FIG. 5, and can engage with a pin 21a that is a protrusion formed at the end of the keyhole 21 as illustrated in FIG. 4. As a result, the unlocking key 5 can be positioned for the length of insertion into the keyhole 21, so as to allow the cylinder lock 10 to be locked and unlocked.

### Cylinder Lock

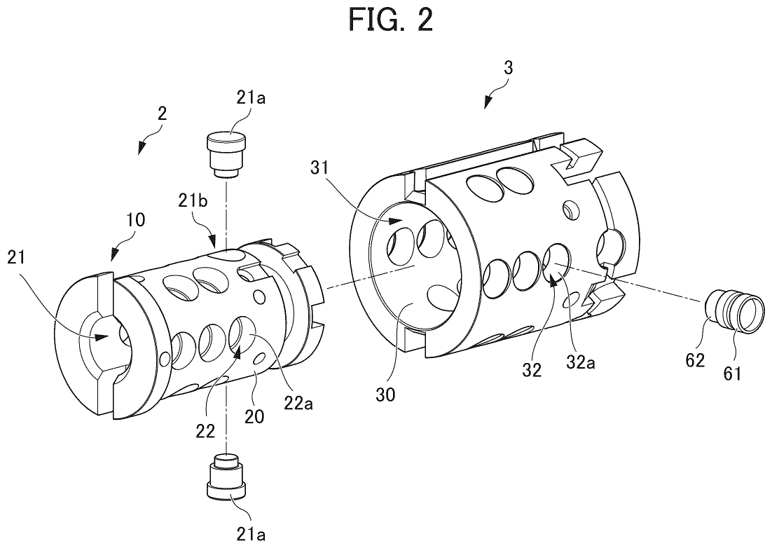

As illustrated in FIGS. 1 and 2, the cylinder lock 10 includes an inner cylinder 2, an outer cylinder 3, a decorative member 4, driver pins 61, and tumbler pins 62. The inner cylinder 2 rotatably engages with the outer cylinder 3 that is fixed.

### Inner Cylinder

As illustrated in FIG. 2, the inner cylinder 2 is a substantially cylindrical member that internally rotatably engages with the outer cylinder 3. The material for the inner cylinder 2 is not particularly limited, and can be made of metal such as brass, for example. The outer peripheral surface 20 being the sliding surface of the inner cylinder 2 contacts the inner peripheral surface 30 of the outer cylinder 3, and engages with the outer cylinder 3. A keyhole 21, into which the unlocking key 5 can be inserted, is formed in the inner cylinder 2 along the axial direction of the inner cylinder 2. In the present embodiment, the cross-sectional shape of the keyhole 21 is circular, corresponding to the projection geometry of the unlocking key 5.

As illustrated in FIG. 2, a plurality of pin holes 22 communicating with the keyhole 21 are formed in the outer peripheral surface 20 of the inner cylinder 2. At least part of the driver pins 61 and the tumbler pins 62 can be inserted into and removed from the plurality of pin holes 22. In the present embodiment, a plurality of sets of pin holes 22 are formed along the axial direction of the inner cylinder 2, and the plurality of sets of pin holes 22 are formed in a plurality of rows in the circumferential direction of the inner cylinder 2.

As illustrated in FIG. 2, pin holes 21b communicating with the keyhole 21 are formed in the outer peripheral surface 20 of the inner cylinder 2, near the end opposite to the side of inserting the unlocking key 5 into the keyhole 21. In the present embodiment, two pin holes 21b are formed at positions symmetrical about the rotational axis of the inner cylinder 2. Two pins 21a are inserted and fixed into the two pin holes 21b. FIG. 4 is a view illustrating the cylinder lock 10, as viewed from the side opposite to the side of inserting the unlocking key 5 into the keyhole 21. As illustrated in FIG. 4, the tips of the pins 21a, as inserted and fixed in the pin holes 21b, form protrusions inside the keyhole 21. The protrusions can engage with the indentations 52 formed at the tip of the unlocking key 5. The protrusions being the tips of the pins 21a have a substantially circular columnar shape, in which the axial directions of the protrusions converge on the center of the keyhole 21.

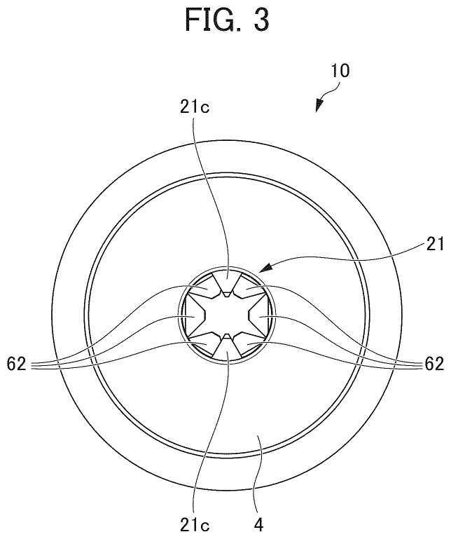

As illustrated in FIGS. 3 and 4, a guide 21c corresponding to the shape of a groove 53 (to be described later) of the unlocking key 5 is formed in the keyhole 21 of the inner cylinder 2. When the unlocking key 5 is inserted into the keyhole 21, the guide 21c restricts the rotation of the unlocking key 5 inside the keyhole 21. Since the guide 21c restricts the rotation, the indentation formed at the tip of the unlocking key 5 can be easily placed in the position where it engages with the protrusion that is the tip of the pin 21a. In the present embodiment, the guide 21c is composed of a pair of protruding pieces having a triangular cross-sectional shape, extending in the axial direction for a predetermined length from near the end side of inserting the unlocking key 5 into the keyhole 21. On the other hand, the position of engaging the protrusion with the indentation can be recognized by the fingers feeling the sensation transmitted, and by the degree of inserting the unlocking key 5 into the keyhole 21, or can be recognized when the unlocking key 5 starts rotating in synchrony with the inner cylinder 2. Therefore, in the case in which the locking device 1 does not have the guide 21c and the groove 53, the user may engage the protrusion with the indentation by rotating the unlocking key 5 inside the keyhole 21. Alternatively, the position of engaging the protrusion with the indentation may be indicated by a mark provided on the unlocking key 5 or the cylinder lock 10.

### Outer Cylinder

As illustrated in FIG. 2, the outer cylinder 3 is a substantially cylindrical member, with which the inner cylinder 2 can internally engage. The material for the outer cylinder 3 is not particularly limited, and can be metal such as brass, for example, as in the case of the inner cylinder 2. The outer cylinder 3 is fixed and not rotatable. The inner peripheral surface 30 being the sliding surface of the outer cylinder 3 contacts the outer peripheral surface 20 of the inner cylinder 2, and engages with the inner cylinder 2. The outer cylinder 3 has a hole 31 formed along the axial direction of the outer cylinder 3, with which the inner cylinder can engage. A plurality of pin holes 32 communicating with the hole 31 are formed in the outer peripheral surface of the outer cylinder 3. At least part of the driver pins 61 and the tumbler pins 62 can be inserted into and removed from the plurality of pin holes 32. When the inner cylinder 2 is rotated to a predetermined position relative to the outer cylinder 3, the plurality of pin holes 22 and 32 communicate with each other such that at least part of the driver pins 61 and the tumbler pins 62 can be inserted or removed.

### Decorative Member

As illustrated in FIGS. 1 and 3, the decorative member 4 covers and decorates the front face of the cylinder lock 10, which is the side of the keyhole 21 of the inner cylinder 2 and the side of the outer cylinder 3. The decorative member 4 has a hole 41 arranged to communicate with the keyhole 21. The material for the decorative member 4 is not particularly limited, and can be metal, etc. A plated layer or the like for enhancing the design may be formed on the surface of the decorative member 4. The decorative member 4 makes the inner cylinder 2 and the outer cylinder 3 almost invisible from the outside. Alternatively, instead of using the decorative member 4, at least the front part of the inner cylinder 2 and the outer cylinder 3 may be decorated with a plated layer formation, for example.

### Driver Pin, Tumbler Pin

The driver pins 61 and the tumbler pins 62 are slidably accommodated in the pin holes 22 and 32. The driver pins 61 are arranged on the side of the keyhole 21, and each have a rounded tip that contacts the unlocking key 5. One end of the tumbler pin 62 contacts the driver pin 61 inside the pin holes 22 and 32, and the other end of the tumbler pin 62 contacts an urging member (not illustrated). Although FIG. 2 illustrates only one set of the driver pin 61 and the tumbler pin 62 for simplicity, there are a plurality of sets of driver pins 61 and tumbler pins 62, which are accommodated in the plurality of sets of pin holes 22 and 32.

The urging member (not illustrated) urges the driver pin 61 and the tumbler pin 62 towards the keyhole 21. When the unlocking key 5 is not inserted into the keyhole 21, the driver pins 61 are positioned between the inner cylinder 2 and the outer cylinder 3, thereby restricting the rotation of the inner cylinder 2. When the unlocking key 5 is inserted into the keyhole 21, the protrusions being the tips of the pins 21a engage with the indentations 52 formed at the tip of the unlocking key 5. In this state, the boundary between the driver pins 61 and the tumbler pins 62 coincides with the boundary between the inner cylinder 2 and the outer cylinder 3 as a result of setting the lengths of the driver pins 61 and the tumbler pins 62 and the indentations formed on the outer peripheral surface of an insertion part 50 of the unlocking key 5. Therefore, by rotating the unlocking key 5 in this state, the inner cylinder 2 rotates in synchrony with the unlocking key 5. As a result, for example, the deadbolt of the door can be pulled out or retracted to lock or unlock the cylinder lock 10.

In the present embodiment, as illustrated in FIG. 3, the driver pins 61 and the tumbler pins 62 are arranged in six directions around the circumference of the circular keyhole 21. The number of the driver pins 61 and the tumbler pins 62 arranged in the circumferential direction of the keyhole 21 is not limited to six, and can be any number such as three or more. Since the keyhole 21 is circular, any number of the driver pins 61 and the tumbler pins 62 can be arranged in the circumferential direction of the keyhole 21. This allows for increasing the number of the driver pins 61 and the tumbler pins 62, thereby enhancing the security level of the locking device 1.

### Unlocking Key

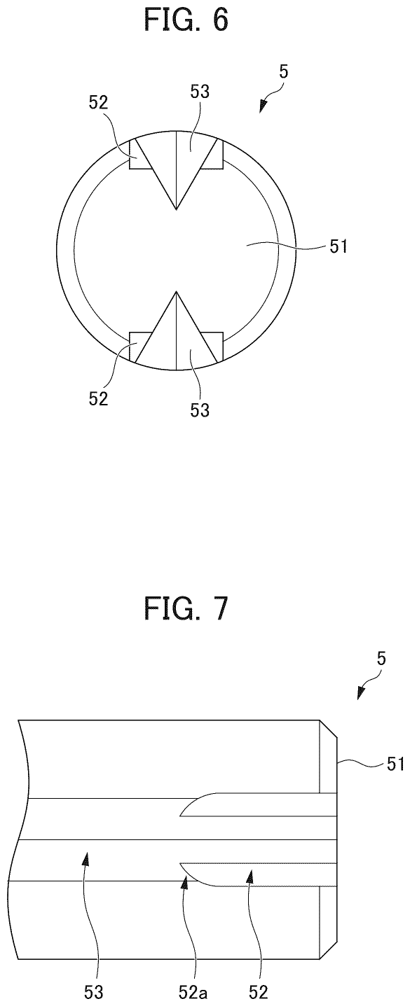

As illustrated in FIGS. 5 and 6, the unlocking key 5 includes the insertion part 50. At least part of the insertion part 50 is inserted into the keyhole 21 and has a circular columnar shape. The drawings illustrate the unlocking key 5 as a blank key. When the unlocking key 5 is actually applied to the cylinder lock 10, indentations corresponding to the length and arrangement of the driver pins 61 and the tumbler pins 62 of the cylinder lock 10 are formed on the outer peripheral surface of the insertion part 50. By forming the insertion part 50 into a circular columnar shape having the indentations thereon, the unlocking key 5 thus produced can be less prone to deformation during machining and have a highly accurate shape, as compared to the conventional cases in which an unlocking key is produced by forming indentations and protrusions on a plate-like key. As a result, the number of the driver pins 61 and the tumbler pins 62 can be increased for the unlocking key 5 of the same size; therefore, high-security locking devices can be produced, even when the installation space remains the same.

As mentioned above, since the unlocking key 5 is manufactured by forming only indentations on the insertion part 50 having the circular columnar shape, the projection geometry of the unlocking key 5 in the direction of insertion into the keyhole can be circular, as illustrated in FIG. 6. When an unlocking key having a circular columnar shape is applied to a cylindrically shaped keyhole, as an approach, protrusions may be provided on the surface of the key having the circular columnar shape in order to prevent the unlocking key from spinning. However, this approach of providing protrusions cannot achieve sufficient machining precision, as compared to the approach of providing indentations. Therefore, the shape of the unlocking key 5 having only indentations formed on the circular columnar shape is preferable. However, the shape of parts other than the insertion part 50 of the unlocking key 5, such as the handle, can be arbitrarily modified to facilitate the operation of the unlocking key 5.

The axial length of the insertion part 50 of the unlocking key 5 can be made longer than the axial length of the keyhole 21. The “axial length of the keyhole 21” refers to the axial length of the keyhole 21 from the end side of inserting the unlocking key 5 to the end side of arranging the protrusions being the tips of the pins 21a. In other words, the cylinder lock 10 according to the present embodiment can achieve the configuration described above, since the unlocking key 5 is positioned for the length of insertion into the keyhole 21 by engaging the indentations 52 provided at the tip of the unlocking key 5 with the protrusions arranged at the end of the keyhole 21. This enables a single unlocking key 5 to lock and unlock different security levels of plural cylinder locks having the keyholes 21 of different axial lengths.

The indentation 52 having a predetermined shape is formed, extending along the axial direction from a tip surface 51, on the outer periphery of the tip of the unlocking key 5. In the present embodiment, the indentation 52 extends along the axial direction of the unlocking key 5. Two indentations 52 are provided at positions symmetrical about the rotational axis of the unlocking key 5. The indentations 52 engage with the protrusions being the tips of the pins 21a in the keyhole 21 of the inner cylinder 2, thereby positioning the indentations on the insertion part 50 at the driver pins 61 and the tumbler pins 62. In this manner, the unlocking key 5 is positioned for the length of insertion into the keyhole 21, so as to allow the cylinder lock 10 to be locked and unlocked. By engaging the indentations 52 with the protrusions, this positioning is achieved, and the unlocking key 5 can rotate in synchrony with the inner cylinder 2. The positioning is achieved by engaging the indentations 52 formed at the tip of the unlocking key 5 with the protrusions being the tips of the pins 21a provided at the end of the keyhole 21; thus, the positioning is also possible when inserting the unlocking key 5 that is longer than the keyhole 21. In other words, since the end of the keyhole 21 serves as the positioning part, the same unlocking key 5 can lock and unlock a plurality of cylinder locks having different keyhole lengths.

Two indentations 52 are formed at positions symmetrical about the rotational axis of the unlocking key 5, and two protrusions corresponding to the indentations 52 are formed at positions symmetrical about the rotational axis of the inner cylinder 2; thus, a reversible type of unlocking key 5 that is usable by rotating 180 degrees can be produced.

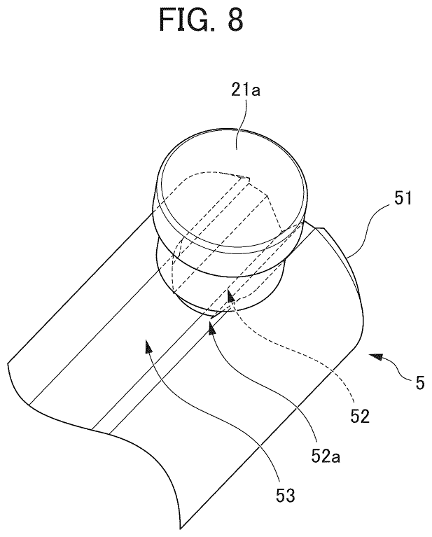

As illustrated in FIGS. 7 and 8, a contact surface 52a of the indentation 52, contacting the protrusion being the tip of the pin 21a, has an arc shape corresponding to the circular columnar shape of the tip of the pin 21a. This allows for easier engagement of the indentation 52 with the protrusion being the tip of the pin 21a, when inserting the unlocking key 5 into the keyhole 21, even with some misalignment in the axes. Additionally, a certain degree of tolerance is provided in the machining precision of both the indentation 52 and the pin 21a.

As illustrated in FIGS. 5 and 6, the grooves 53 are formed in the unlocking key 5. Each groove 53 has a triangular cross-sectional shape corresponding to the shape of the guide 21c. The grooves 53 are formed along the axial direction, from the tip surface 51 of the unlocking key 5. Since the insertion part 50 has a circular columnar shape and may rotate within the keyhole 21 when the unlocking key 5 is inserted into the keyhole 21, the grooves 53 and the guides 21c are provided for positioning the indentations 52 to engage with the protrusions being the tips of the pins 21a. Thus, when the unlocking key 5 is inserted into the keyhole 21, the end of the groove 53 does not contact the surface of the guide 21c on the side of inserting the unlocking key 5, and there is a certain clearance between the groove 53 and the guide 21c.

As illustrated in FIG. 7, as in the case of the indentation 52, the groove 53 extends along the axial direction of the unlocking key 5 and is arranged adjacent to the indentation 52. Furthermore, two grooves 53 are provided axisymmetrically to the insertion part 50, corresponding to the number of the guides 21c. However, this configuration is a non-limiting example. Furthermore, the number of the grooves 53 and the guides 21c is not particularly limited.

### Second Embodiment

Next, the configuration of a locking device 1a according to the second embodiment of the present disclosure is described. In the following description, identical reference numerals are assigned to the components that are the same as in the first embodiment, and the description may be omitted.

### Locking Device

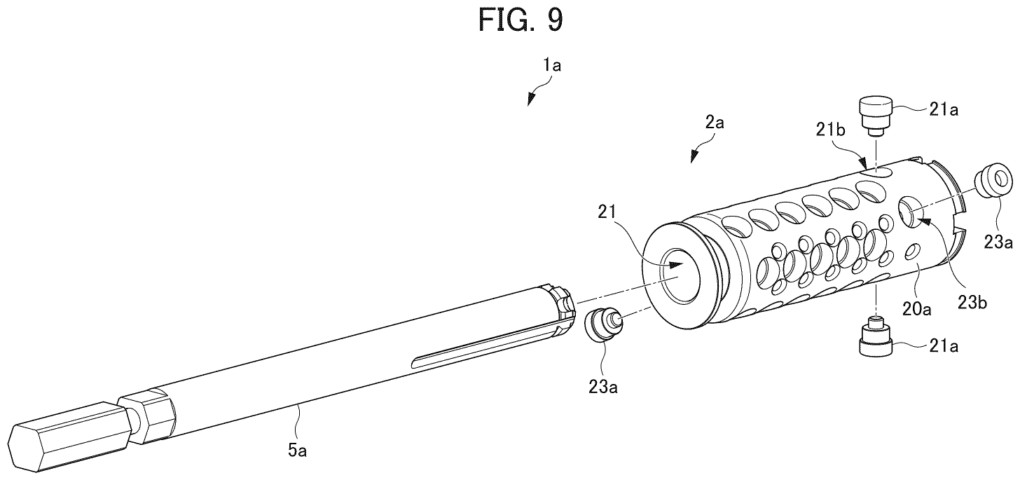

As illustrated in FIGS. 9 to 11, the locking device 1a in the present embodiment includes a cylinder lock 10a and an unlocking key 5a that can lock and unlock the cylinder lock 10a by being inserted into the keyhole 21 of the cylinder lock 10a.

### Cylinder Lock

The cylinder lock 10a includes an inner cylinder 2a. The configuration of the cylinder lock 10a, other than the inner cylinder 2a, is the same as the first embodiment. FIG. 9 omits the illustration of the outer cylinder 3.

### Inner Cylinder

The inner cylinder 2a is a substantially cylindrical member that internally rotatably engages with the outer cylinder 3. As illustrated in FIG. 9, pin holes 21b and 23b communicating with the keyhole 21 are formed near the end opposite to the side of inserting the unlocking key 5 into the keyhole 21, in the outer peripheral surface 20a of the inner cylinder 2a. Two pin holes 23b are formed at positions symmetrical about the rotational axis of the inner cylinder 2a, as in the case of the pin holes 21b. Two pins 23a are inserted and fixed in the two pin holes 21b. That is, in the present embodiment, in addition to the two pins 21a, two more pins 23a are inserted and fixed in the inner cylinder 2a through the pin holes.

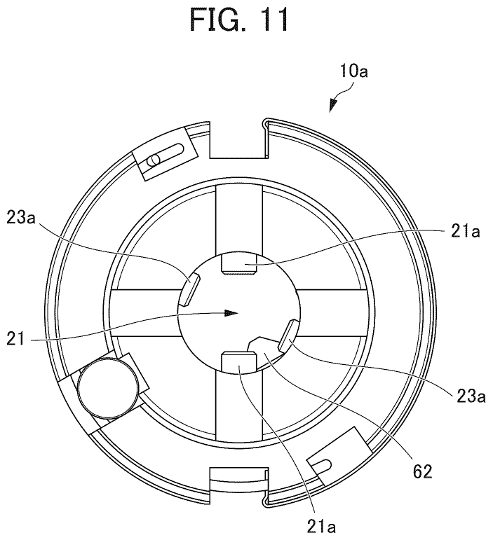

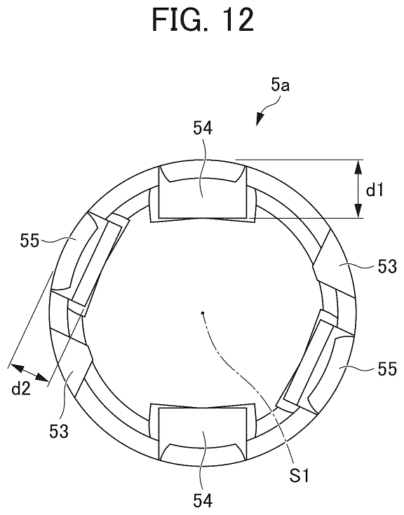

FIG. 11 illustrates the cylinder lock 10a, as viewed from the side opposite to the side of inserting the unlocking key 5a into the keyhole 21. As illustrated in FIG. 11, when the pins 23a are inserted and fixed in the pin holes 21b, the tips of the pins 23a form protrusions that protrude into the keyhole 21, as in the case of the pins 21a. In the present embodiment, the protrusions formed by the pins 21a protrude more into the keyhole 21 than the protrusions formed by the pins 23a.

### Unlocking Key

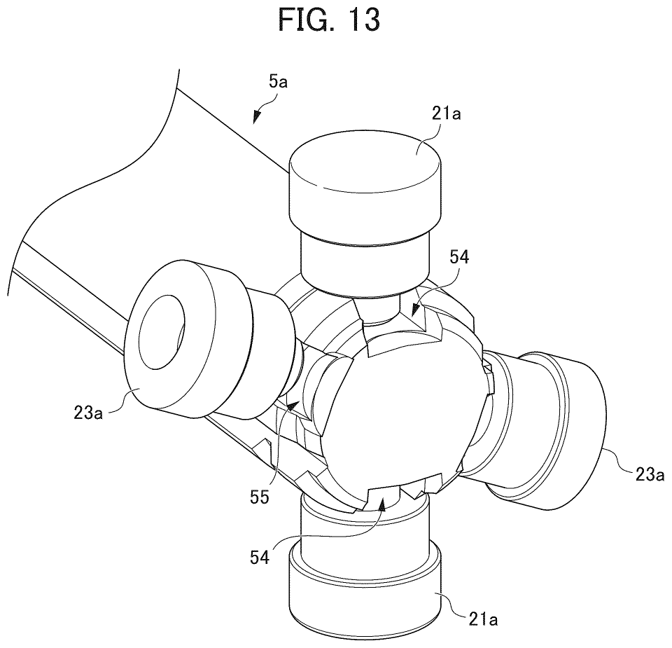

As illustrated in FIGS. 12 to 14, indentations 54 and 55 having a predetermined shape are formed on the outer periphery of the tip of the unlocking key 5a, along the axial direction from the tip surface 51. The indentations 54 and 55 extend along the axial direction of the unlocking key 5a. Each of the indentations 54 and 55 is a pair of indentations formed symmetrically about the rotational axis S1 of the unlocking key 5a. The indentation 54 engages with the protrusion formed by the pin 21a, and the indentation 55 engages with the protrusion formed by the pin 21a. As illustrated in FIG. 12, the depth d1 of the indentation 54 is greater than the depth d2 of the indentation 55. The depth d1 corresponds to the amount of protrusion formed by the pin 21a into the keyhole 21, and the depth d2 corresponds to the amount of protrusion formed by the pin 23a into the keyhole 21. This ensures that only the protrusion formed by the pin 21a engages with the indentation 54, and only the protrusion formed by the pin 23a engages with the indentation 55. Therefore, even when there are a plurality of sets of such protrusions and indentations, the unlocking key 5a can be positioned in the rotational direction. The above configuration may be altered such that the corresponding protrusions and indentations match in size in width-wise dimensions.

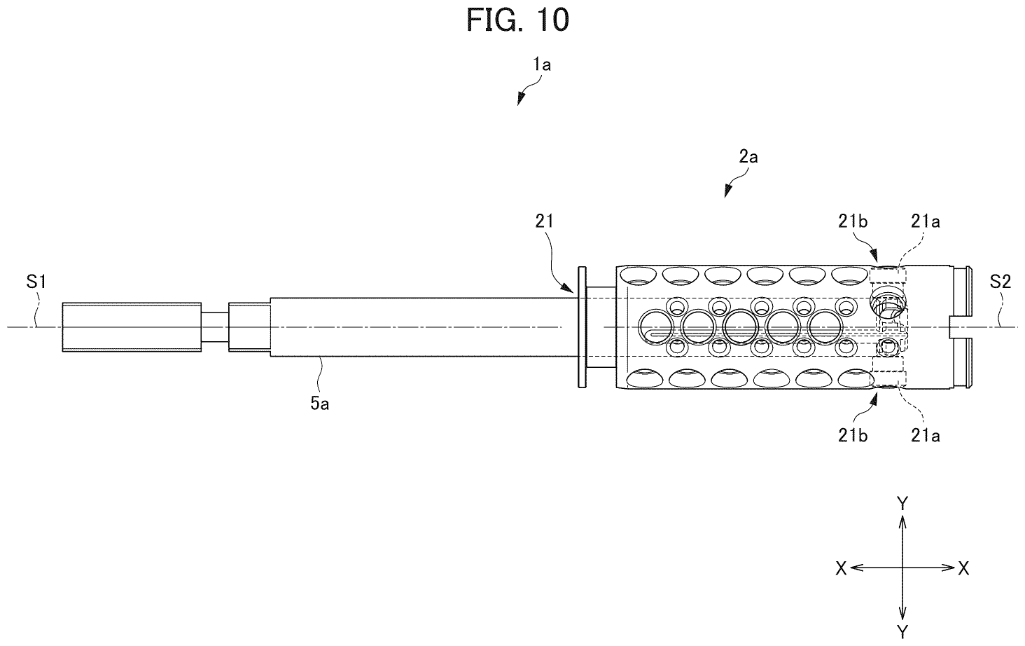

As mentioned above, the plurality of sets of indentations are formed on the unlocking key 5a at positions symmetrical about the rotational axis S1, and engage with the plurality of sets of protrusions protruding into the keyhole 21. For explanatory purposes, FIG. 10 illustrates an example, in which one set of protrusions in the keyhole engages with one set of indentations on the unlocking key. FIG. 10 is a side view of the locking device Ta, in which the inner cylinder 2a and the unlocking key 5a are viewed from the side, illustrating only one set of pins 21a, omitting one set of pins 23a.

In the configuration illustrated in FIG. 10, the protrusions formed by the pair of pins 21a engage with the pair of indentations 54, enabling the unlocking key 5a to be positioned for the length of insertion into the keyhole 21 (positioned in the X-direction in FIG. 10). However, there is a certain clearance between the keyhole 21 (inner peripheral surface of the inner cylinder 2a) and the unlocking key 5a, disabling precise positioning in the Y-direction illustrated in FIG. 10. In other words, the rotational axis S1 of the unlocking key 5a does not coincide with the rotational axis S2 of the inner cylinder 2a, which are not even parallel. By contrast, the plurality of sets of indentations are formed at the positions symmetrical about the rotational axis of the unlocking key 5a, and the plurality of sets of corresponding protrusions are formed inside the keyhole 21, thereby allowing the positioning in the Y-direction, and the rotational axis S1 of the unlocking key 5a can coincide with the rotational axis S2 of the inner cylinder 2a as closely as possible. As a result, more accurate indentations and protrusions can be formed on the unlocking key 5a, and the number of the driver pins 61 and the tumbler pins 62 per area can be increased, corresponding to the shapes.

In the configuration described above, the plurality of sets of indentations are formed at the positions symmetrical about the rotational axis S1 of the unlocking key 5a; however, this is a non-limiting example. The indentations and the corresponding protrusions are formed at the positions symmetrical about the rotational axis, which is for the purpose of producing a reversible type of unlocking key 5a. Therefore, if the unlocking key does not need to be a reversible type, a plurality of sets of indentations and protrusions do not need to be formed at positions symmetrical about the rotational axis. Furthermore, even when a plurality of sets of indentations are formed at positions symmetrical about the rotational axis S1 of the unlocking key 5a, the arrangement of the plurality of sets of indentations is not limited to the configuration illustrated in FIG. 12, and can be any arbitrary arrangement. In the present embodiment, two sets of indentations are illustrated, but three or more sets of indentations may be formed. The indentations described above refer to those engage with the positioning protrusions formed at the end of the keyhole 21. Therefore, the number of indentations does not necessarily have to match the number of protrusions, and any indentations, which do not engage with the protrusions formed in the keyhole 21, may be formed on the unlocking key 5a.

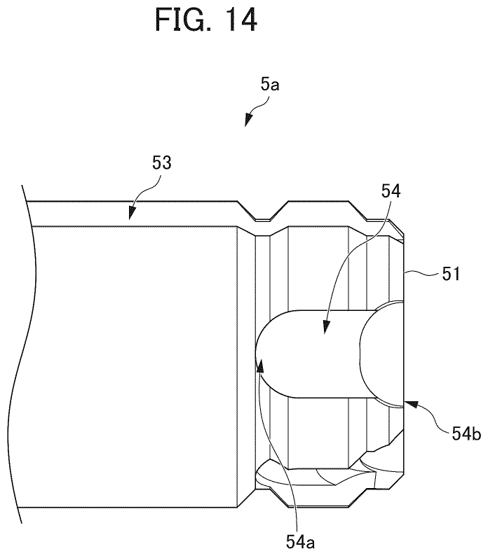

As illustrated in FIGS. 13 and 14, the contact surface 54a of the indentation 54, contacting the protrusion being the tip of the pin 21a, has an arc shape corresponding to the circular columnar shape of the tip of the pin 21a. Furthermore, an opening 54b of indentation 54, into which the pin 21a is inserted, is formed in an arc shape and is wider than the width of the contact surface 54a. This configuration allows the tip of the pin 21a to be smoothly inserted into the indentation 54. The indentation 55 also has an opening similar to the above.

### Door

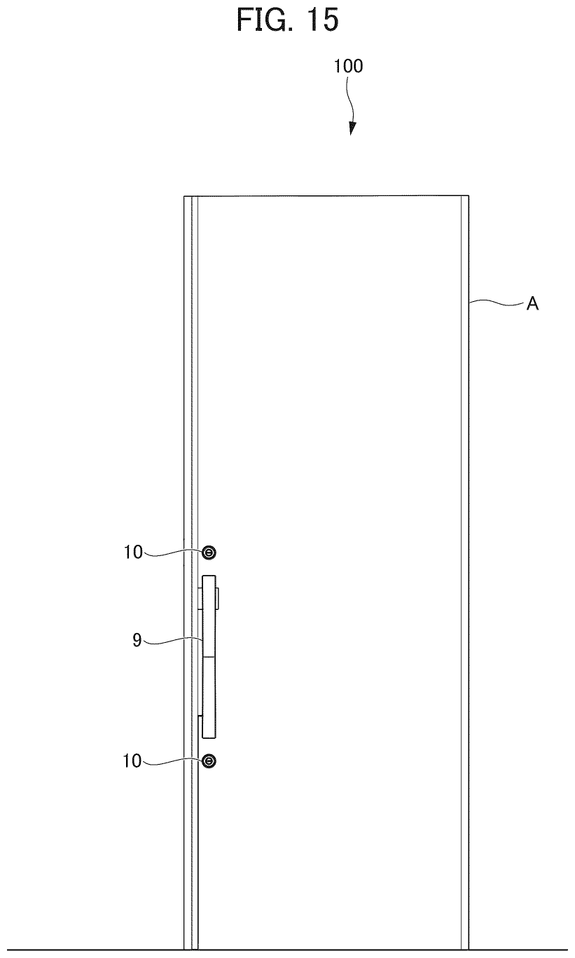

As illustrated in FIG. 15, a door 100 according to the present embodiment is installed so as to be openable and closable, in a door opening A of a building structure. On the door front side, the door 100 includes a handle 9 for opening and closing the door 100, and a pair of cylinder locks 10 arranged above and below the handle 9. The door 100 is used, for example, as a front door. Instead of the cylinder lock 10, the cylinder lock 10a according to the second embodiment may be applied.

The locking devices 1 and 1a are not limited to front doors, but can be applied to any doors or gates where security is required, such as service doors, terrace doors, gates, interior doors, etc. Furthermore, the locking devices 1 and 1a can be applied not only to building fixtures but also to other objects where cylinder locks can be applied, such as parcel delivery boxes.

The cylinder locks according to the embodiments of the present disclosure have been described above. However, the present disclosure is not limited to the embodiments and can be modified as appropriate. The present disclosure includes the following aspects of the locking device, unlocking key, and door.

### Aspect 1

A locking device, which includes:
a cylinder lock including an outer cylinder and an inner cylinder that rotatably engages with the outer cylinder; and
an unlocking key corresponding to a keyhole formed in the inner cylinder; in which
a protrusion is formed at an end of the keyhole, and
an indentation for positioning, which can engage with the protrusion, is formed at a tip of the unlocking key.

### Aspect 2

The locking device as described in Aspect 1, in which the indentation is formed in plural, on an outer periphery of the tip of the unlocking key.

### Aspect 3

The locking device as described in Aspect 1 or 2, in which the unlocking key includes an insertion part insertable into the keyhole, and the insertion part has a circular columnar shape.

### Aspect 4

The locking device as described in any one of Aspects 1 to 3, in which a contact part that forms an area of contact between the protrusion and the indentation has an arc shape.

### Aspect 5

The locking device as described in any one of Aspects 1 to 4, in which the projection geometry of the unlocking key in the direction of insertion into the keyhole is circular.

### Aspect 6

The locking device as described in any one of Aspects 1 to 5, in which a guide is formed in an insertion hole of the keyhole, so as to restrict rotation of the unlocking key to a position where the protrusion engages with the indentation, and a groove corresponding to the shape of the guide is formed in the unlocking key.

### Aspect 7

The locking device as described in Aspect 6, in which the indentation and the groove extend along an axial direction of the unlocking key, and are arranged adjacent to each other.

### Aspect 8

The locking device as described in any one of Aspects 1 to 7, in which the axial length of the insertion part of the unlocking key is longer than the axial length of the keyhole.

### Aspect 9

An unlocking key used for the locking device as described in any one of Aspects 1 to 8.

### Aspect 10

A door including the cylinder lock of the locking device as described in any one of Aspects 1 to 8.

1. A locking device, comprising:
a cylinder lock including an outer cylinder and an inner cylinder that rotatably engages with the outer cylinder; and
an unlocking key corresponding to a keyhole formed in the inner cylinder, wherein
a protrusion is formed at an end of the keyhole, and
a positioning indentation engageable with the protrusion is formed at a tip of the unlocking key.

2. The locking device of claim 1, wherein
the indentation is formed in plural, on an outer periphery of the tip of the unlocking key.

3. The locking device of claim 1,
wherein the unlocking key includes an insertion part insertable into the keyhole, the insertion part having a circular columnar shape.

4. The locking device of claim 1, wherein a contact part that forms an area of contact between the protrusion and the indentation has an arc shape.

5. The locking device of claim 1, wherein
a projection geometry of the unlocking key in a direction of insertion into the keyhole is circular.

6. The locking device of claim 1, wherein
a guide is formed in an insertion hole of the keyhole, so as to restrict rotation of the unlocking key to a position where the protrusion engages with the indentation, and
a groove corresponding to the shape of the guide is formed on the unlocking key.

7. The locking device of claim 6, wherein
the indentation and the groove extend along an axial direction of the unlocking key, and are arranged adjacent to each other.

8. The locking device of claim 1, wherein
an axial length of the insertion part of the unlocking key is longer than an axial length of the keyhole.

9. An unlocking key used for the locking device of claim 1.

10. A door comprising the cylinder lock of the locking device of claim 1.

11. The locking device of claim 2, wherein
the indentation formed in plural comprises a plurality of sets of the indentations arranged on the unlocking key at positions symmetrical about the rotational axis.

12. The locking device of claim 11,
wherein the unlocking key includes an insertion part insertable into the keyhole, the insertion part having a circular columnar shape.

13. The locking device of claim 11, wherein a contact part that forms an area of contact between the protrusion and the indentation has an arc shape.

14. The locking device of claim 11, wherein
a projection geometry of the unlocking key in a direction of insertion into the keyhole is circular.

15. The locking device of claim 11, wherein
a guide is formed in an insertion hole of the keyhole, so as to restrict rotation of the unlocking key to a position where the protrusion engages with the indentation, and
a groove corresponding to the shape of the guide is formed on the unlocking key.

16. The locking device of claim 11, wherein
an axial length of the insertion part of the unlocking key is longer than an axial length of the keyhole.

17. An unlocking key used for the locking device of claim 11.

18. A door comprising the cylinder lock of the locking device of claim 11.
